(19) United States
(12) Patent Application Publication
(10) Pub. No.: US 2018/0116174 A1
(43) Pub. Date: May 3, 2018

(54) ANIMAL DRINKER AND DRIP CUP FOR AN ANIMAL DRINKER

(71) Applicant: Barnstorfer Kunststofftechnik GmbH & Co. KG, Barnstorf (DE)

(72) Inventor: Egon Schumacher, Barnstorf (DE)

(73) Assignee: Barnstorfer Kunststofftechnik GmbH & Co. KG, Barnstorf (DE)

(21) Appl. No.: 15/701,509

(22) Filed: Sep. 12, 2017

(30) Foreign Application Priority Data
Nov. 2, 2016 (DE) 202016006727.4

(51) Int. Cl. A01K 7/00; A01K 39/02

(52) U.S. Cl. CPC A01K 7/005; A01K 39/02

(57) ABSTRACT

Drip cups used in animal drinkers for beaked animals feature a cup body made of plastic material for accommodating a supply of water. The cup body has a bottom surrounded by an edging. Experience has shown that beaked animals cause damage to the plastics material of cup body with their beaks. Such damage by pecking can even cause the bottom, and thus the drip cup itself, to leak water. The invention proposes to position a graduated metal insert centered in the inside bottom of the cup body. The insert thereby reinforces the bottom of the cup body such that beaked animals are no longer capable of damaging the drip cup.

### STATEMENT OF RELATED APPLICATIONS

This application claim the benefit of and priority on German patent application number 20 2016 006 727.4 having a filing date of 2 Nov. 2016

### BACKGROUND OF THE INVENTION

### Technical Field

The invention relates to a drip cup for an animal drinker for beaked animals such as chickens, ducks, turkeys and chicks, with a cup body made of plastic material for accommodating a supply of water and having a bottom and edging surrounding the latter, wherein the bottom is assigned a preferably central insert made of a resistant material, and with at least one supporting arm for connecting the cup body to a water supply line, and to an animal drinker having at least one drip cup for beaked animals such as chickens, ducks, turkeys, chicks and the like, having at least one drinker valve positioned on a water supply line.

### Prior Art

Animal drinkers for beaked animals, in particular poultry, such as hens, turkeys, ducks, chickens or the like, have drip cups. The drip cups are conventionally assigned drinker valves which are connected to a preferably strand-like water supply line.

The animals are able to actuate the drinker valves automatically in such a manner that they dispense water. At least part of this water collects in cup bodies of the drip cups. The animals take the required water out of the cup bodies. The animals can also cover part of their water requirements by catching the water dispensed from the respective drinker valve directly in their beaks. This water can be tap water, but also tap water with additives, for example medicines. In the following, references made to “water” also include water containing additives.

The drip cups, or at least their cup bodies, are conventionally made of plastic material, for example thermoplastic material. The animals, in particular when they are mature, can damage the plastic material of at least the cup bodies of the drip cups with their beaks. This occurs, for example, when the animals peck against the inside bottom surfaces of the cup bodies with their beaks to take the remaining water. This results over time in holes in the region of the deepest point of the cup body where the remaining water collects. In this way the cup bodies of the drip cups are veritably punctured by the pecking activity of the animals.

### BRIEF SUMMARY OF THE INVENTION

The invention is based on the object of creating a drip cup and an animal drinker having at least one such drip cup whose cup bodies cannot be pierced by animal pecking, but which at the very least are more resistant to such pecking.

A drip cup for achieving the aforementioned object comprises a cup body made of plastic material for accommodating a supply of water and having a bottom and edging surrounding the latter, wherein the bottom is assigned a preferably central insert made of a resistant material, and with at least one supporting arm for connecting the cup body to a water supply line, characterized in that the insert has a graduated configuration. Accordingly, the cup body is assigned an insert, preferably at a position where remaining water collects, which is stepped or graduated. As a result, a depression is formed in the insert to accommodate the remaining water still present in the cup body of the drip cup. In order to take the remaining water from the drip cup, the animals then peck at the insert. Because the latter is more resistant than the plastic material of the rest of the cup body, this reliably prevents the cup body from being punctured by pecking.

It is preferably provided that the insert is stepped or graduated in the manner of a hat, in particular a top hat. This allows for the formation of a depression of sufficient size in the insert.

It is further preferably provided that the depression is arranged in inside the insert, preferably at its center, with this depression being achieved by the stepped and/or graduated configuration of the insert, in particular of its inner or central part. This results in a pan-shaped depression in the insert in which the remaining water of the drip cup can collect. By virtue of appropriate dimensioning, namely that of the bottom surface and/or depth of the depression, the amount of water to be taken from it can be predefined according to requirements. The depression is at least configured for accommodating such a quantity of water remaining in the drip cup which the animals are induced to peck. By ensuring that the animals peck only in the region of the insert on the inside cup surface, it is sufficient to provide the insert made of resistant material only in a central, interior part at the bottom of the cup body.

The depression preferably has a collar, in particular a raised collar, which encompasses an inside surface and an outer edge of the depression. This creates the top hat shape of the depression. Such a depression can be easily formed, for example by deformation, above all by cold deformation, using a flat blank for forming the insert.

According to a preferred further development of the insert, it is provided that an upper edge of the circumferential collar of the depression is assigned a preferably planar ring or a ring disc. The ring disc then surrounds the upper outer edge of the collar of the depression. The ring disc also protects a region of the bottom of the cup body of the insert from being damaged by the beaks of the animals. This contributes to an improved effectiveness of the insert formed from material resistant to the beaks of the animals.

In the case of an advantageous further development of the insert, its inside surface and/or ring disc is configured to be planar, at least approximately planar or slightly curved in a deepening manner toward the center. Particular in the case of a planar inside surface, the remaining water is distributed over the entire bottom surface of the depression of the insert. This creates sufficient space for a number of beaks, enabling a plurality of animals to take up the remaining water from the drip cup at the same time. Nevertheless, the inside surface can also have a slight curve and thus assume a spherical configuration such that the deepest point of the spherical inside surface lies approximately at the center of the depression. The remaining water can then collect precisely in this central and lowest point of the depression, thus allowing the animals to take up even small residual quantities of the water from the cup body.

It is preferably provided that the inside surface and the ring disc of the insert are arranged in different, parallel planes or also only in slightly curved planes that are rotationally symmetrical. The inside surface of the depression thereby lies below the ring disc. It can be provided that the inside surface lies 1.5 mm to 0.3 mm, preferably 1 mm to 0.5 mm, below the surface of the ring disc. This creates a sufficient reservoir for remaining water in the region of the insert and ensures that the cup body is not pierced by the pecking of the animal's beaks.

A further preferred possible design for the drip cup provides that the insert is configured such that an outer edge of its ring disc is encompassed by a collar. This is preferably a double-angled collar with an approximately L-shaped profile. While the ring disc is graduated or stepped at a circumferential inner edge by the depression, the double-angled collar creates a further graduation at the outer circumferential edge of the ring disc. The outer graduation created by the double-angled collar serves preferably to fix the insert in or on the bottom of the cup body.

The collar is preferably double-angled in such a manner that a limb of the same, which has a free end, lies at least in part in the plane of the inside surface of the depression of the insert. However, the limb can also lie slightly above or below the plane running through the inside surface of the insert. What is decisive is that the top side of the limb lies below the top side of the ring disc, in particular above an upper plane thereof.

In the case of an advantageously designed drip cup, it is provided that the depression of the insert has a circular inside surface and that the ring disc is configured in the shape of a circular ring. This favors the accumulation of remaining water in the region of the insert of the cup body. The round or circular surfaces also result in good accessibility to the cup body on all sides simultaneously, in particular to its central part, for the beaks of a number of animals.

One possible advantageous design of the insert provides that the latter is configured as a single piece. Such a one-piece insert can be formed by the deformation and/or pressing of a circular shaped blank, in particular by means of cold deformation, but also in a press mold.

Possible preferred materials for the insert are steel, in particular stainless steel, aluminum, fiberglass reinforced plastic, ceramics or similar resilient materials. These materials are extremely resistant to wear or other damage caused by the beaks of the animals, with the result that when said materials are employed in the region of the insert the animals are unable to peck through the bottom of the cup body.

Further, it can be provided that at least the inner side of the entire insert which comes into contact with the animals' beaks, or at least an inside part thereof, has a course surface or is roughened. This allows the animals to take care of their beaks by wearing them away on the facing surfaces of the insert.

According to a preferred further development of the drip cup, provision is made to recess and/or embed the insert in the bottom of the cup body. The insert is preferably recessed and/or embedded in the region of the lowest point of the bottom. Usually the lowest point of the bottom lies at its center if the bottom is slightly concave on all sides, whereby the lowest position is at the center of the bottom. The remaining liquid then collects in the depression of the insert, which is graduated or stepped to form the depression, even in cases where the drip cups are somewhat tilted on account of slightly inclined water supply lines. But as an alternative it can be provided that the bottom of the cup body has a flat bottom. Generally the remaining water will also collect, at least for the most part, in the depression of the insert. The insert is preferably positioned in the bottom of the cup body in such a manner that an top side of the ring disc of the insert is recessed in the bottom only so far that the ring disc is flush with an inside surface of the bottom, while the sub-adjacent collar surrounding the ring disc is embedded in the bottom of the cup body in that it is covered by the plastic material of the inside surface of the cup body. Since the collar surrounding the outside of the ring disc is completely embedded in the plastic material of the cup body, this collar lies completely covered on all sides in the plastic material of the bottom of the cup body, so that the insert is permanently fixed in the bottom of the cup body in a form-fit manner and the ring disc surrounding the depression is recessed into the bottom of the cup body until only the top side of the ring disc is flush with the inside surface of the cup body and thus not covered by the plastic material of the cup body. This creates a continuous transition from the plastic material of the cup body to the outer circumference of the ring disc of the insert. Only an inside region of the insert itself is graduated in that its inside surface lies deeper than the ring disc for the formation of a depression in the middle or central region of the insert for the purpose of forming the depression for accommodating remaining water. In this manner, the ring disc forms a kind of dike around the lower-lying inner surface, with the depression not being filled out with plastic material during its production and thus remaining empty in order to accommodate residual water.

Provision is also made to cover a bottom side of the entire insert with the plastic material of an external cup surface of the cup body. The bottom side of the insert is thereby completely covered by plastic material and thus embedded as a whole in the bottom of the cup body.

An animal drinker for achieving the object set forth at the start has a drip cup which is at least partially configured in the manner described above. The drip cups of such an animal drinker are protected by their inserts from damage caused by the beaks of the animals, in particular from being punctured by pecking.

### BRIEF DESCRIPTION OF THE DRAWINGS

Preferred exemplary embodiments of the invention will be explained in more detail below by way of the drawing in which:

FIG. 1 shows a perspective view of the first exemplary embodiment of a drip cup with only a single supporting arm,

FIG. 2 shows a vertical section through the single supporting arm of the drip cup of FIG. 1,

FIG. 3 shows a side view of the drip cup of FIGS. 1 and 2,

FIG. 4 shows an enlarged detail IV from the sectional view of FIG. 2 in the region of an insert in the bottom of a cup body of the drip cup,

FIG. 5 shows a perspective view of a drip cup with two supporting arms pursuant to a second exemplary embodiment of the invention,

FIG. 6 shows a central vertical section between the two supporting arms of the drip cup of FIG. 5,

FIG. 7 shows a side view of the drip cup of FIGS. 5 and 6, and

FIG. 8 shows an alternative exemplary embodiment of the insert in a representation analogous to FIG. 4.

### DETAILED DESCRIPTION OF PREFERRED EMBODIMENTS

The shown drip cups are intended for animal drinkers. In particular, the animal drinkers are so-called strand drinkers for the floor keeping of beaked animals, especially poultry. The animal drinkers make it possible for poultry of various ages, above all hens, ducks, turkeys, geese or the like, to cover their water requirement themselves.

The animal drinker is configured as a strand drinker having an elongated, tube-like water supply line with a plurality of drinker points that are spaced apart from one another. Preferably all the drinker points are realized in an identical manner. The invention is also suitable, however, for animal drinkers with only one single drinker point having a suitable water supply.

Each drinker point comprises substantially one drinker valve and one drip cup. The respective drinker valve is screwed or inserted with a housing into the water supply line from below. The drinker valve has a valve pin which projects out of the housing by way of a bottom, free actuating end. The actuating end of the respective drinker valve can be pivoted and/or lifted by the beaks of the animals. As a result, the drinker valve is opened, thereby dispensing water, specifically water or water containing an additive. This involves relatively small quantities of water, which flows or drips out of the drinker valve until the animals let go of the actuating end with their beaks, with the valve pin then returning to its unactuated initial position, which closes the drinker valve.

When the drinker valve is opened by the beaks of the animals, the water dispensed from the same is immediately taken up by the animals only in part or not at all. The entire water or just the surplus water then accumulates in the respective drip cup. The animals then take the water, above all the remaining water, from the drip cup.

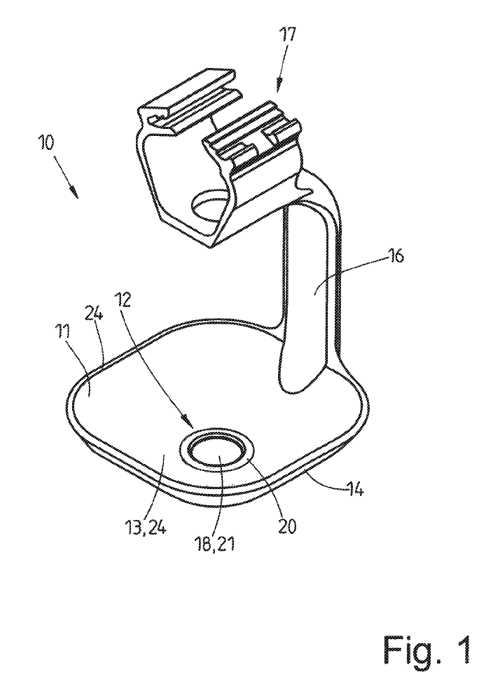

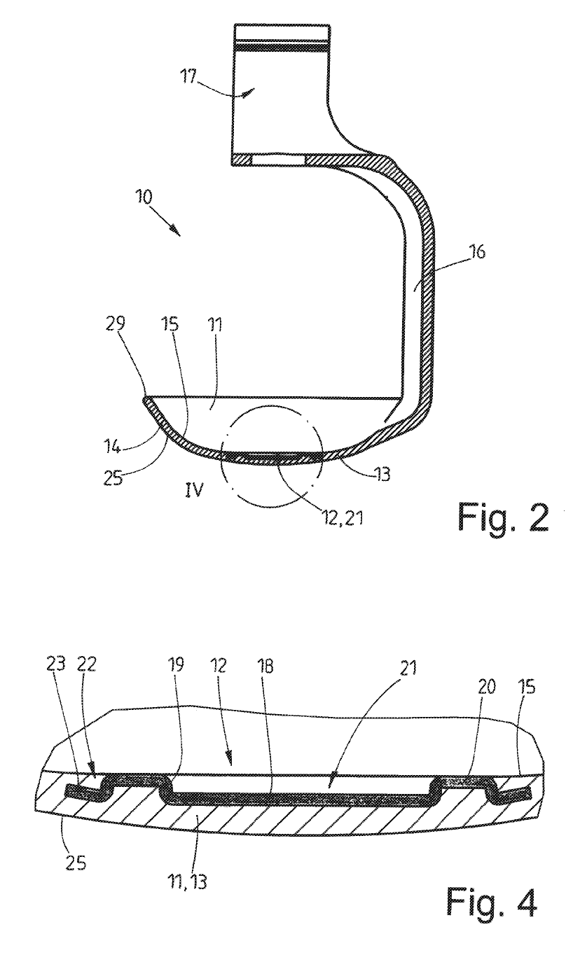

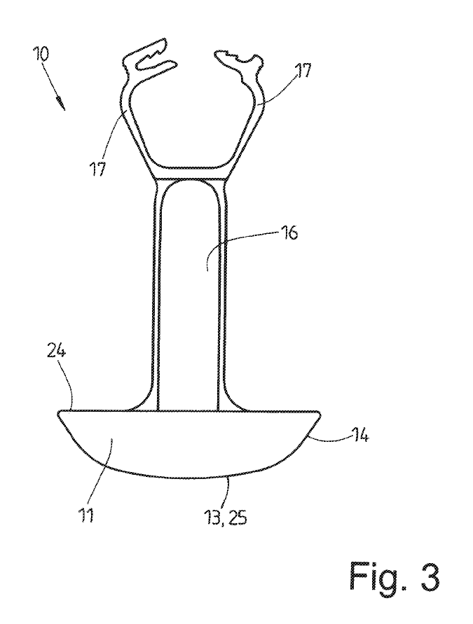

The drip cup 10 shown in FIGS. 1 to 4 has a cup body 11 and an insert 12 for accommodating a supply of water. The cup body 11 has a bottom which is surrounded by a circumferential, raised edging 14. The insert 12 is assigned to the bottom 13, specifically its inside bottom surface 15. In the shown exemplary embodiment, the insert 12 is positioned approximately at the center of the bottom 13. The insert 12 is preferably entirely or at least for the most part recessed in the bottom 13 of the cup body 11. In the shown exemplary embodiment the insert 12 is also partially embedded in the bottom 13. The bottom 13 of the insert 12 in the shown drip cup 10 is slightly concave all around, so that the lowest point is located at the center, specifically at the position where the insert 12 is also positioned.

The drip cup 10 shown in FIGS. 1 to 4 has a single supporting arm 16. The supporting arm 16 proceeds from the upper edge 24 of the edging 14 and extends vertically upwards perpendicular to the plane of the 13 of the cup body 11. A higher end of the supporting arm 16 opposite the cup body 11 is joined to a fastening means for the drip cup 10, for example to a strand-like water supply line. In the shown exemplary embodiment, this fastening means is realized as a clip closure 17. This allows for a detachable connection between the drip cup 10 and the water supply line. However, other types of fastening means are conceivable.

Apart from the insert 12, the drip cup 10 is made completely of plastic material. The drip cup is preferably made of thermoplastic material using the injection molding method. The drip cup 10, apart from the insert 12, is thereby formed as a single piece in which the cup body 11 with the bottom 13 and the edging 14, as well as the supporting arm 16 and the clip closure 17 are integrally connected.

The insert 12 is made from a material that is more durably resistant in comparison to the plastic material of the drip cup 10. This material can be steel, preferably stainless steel, fiberglass reinforced plastic, aluminum or even ceramics. These materials cannot be damaged by the beaks of the animals. The beaks of the animals are therefore not capable of pecking through such inserts 12. In addition, an insert 12 made from one of the aforementioned materials can aid in wearing away the beaks of the animals, especially if the inside surface of the insert 12 is coarse or roughened.

The insert 12 is suitable, in particular designed, for being inserted or placed in an injection mold for the production of the drip cup 10. In the injection molding process, the insert 12 is then overmolded in part by plastic, in particular its entire rear side and in an outer annular region, with the insert 12 being recessed and/or embedded in the bottom 13 of the cup body 11.

FIG. 4 shows the cross-section view of the insert 12 and its arrangement in the bottom 13 of the cup body 11.

The shown insert 12 made from a sheet of preferably stainless steel is stamped, in particular by means of cold deformation. This results in the graduated or stepped insert 12. By virtue of stamping and/or cold deformation, the insert 12 is given a circular, lower-lying inside surface 18 that is surrounded by a circumferential, cylinder-like collar 19, resulting in an insert 12 having a pan-shaped depression 21. The thickness of the wall or sheet metal of the insert 12 is between 0.4 mm and 0.8 mm, preferably between 0.5 mm and 0.7 mm.

In the shown insert 12, the inside surface 18 has a planar configuration in that it runs diametrically in a linear fashion, as can be seen in FIG. 4. An edge of the collar 19 which is directed away from the inside surface 18 and lying above it is adjoined by a circumferential ring, which in the shown exemplary embodiment is realized as an planar ring disc 20. The ring surface area of the ring disc 20 also lies on a flat, lineal surface. This surface runs parallel to the inside surface 18, but slightly above the latter. The distance between the top side of the inside surface 18 and the top side of the ring disc 20 can range from 0.5 mm to 2.0 mm. Preferably the distance is between 1.0 mm and 1.5 mm. This distance corresponds to the depth of the depression 21 of the insert 12 formed between the inside surface 18 and the ring disc 20 situated above the latter. The diameter of the depression 21 corresponds to the diameter of the inside surface 18 or the inner side of the collar 19 or the diameter of the inside edge of the ring disc 20. In the case of the insert 12 shown, this diameter measures between approximately 10 mm to 20 mm, preferably approximately 14 mm to 18 mm.

The outer edge of the ring disc 20 is surrounded by a second circumferential collar 22. This collar 22 has an L-shaped profile with a shorter limb adjacent to the outer edge of the ring disc 20 which, similar to the collar 19, forms a cylinder-like part of the collar 22, and a relatively longer limb 23, which is angled by approximately 90° with respect to the shorter limb. Due to the L-shaped configuration of the collar 22, the insert 12 has a second, outer graduation or stepping. As a result, the longer limb 23 of the collar 22 lies below the ring disc 20, that is to say approximately in the plane of the inside surface 18 or slightly above it (FIG. 4).

FIG. 8 shows an alternative exemplary embodiment of the insert 12. The configuration and dimensioning of this insert 12 corresponds to that of the previously described insert 12, in particular the insert 12 shown in FIG. 4. The insert 12 of FIG. 8 is also stamped from thin-walled sheet metal made of stainless steel.

Instead of a planar inside surface 18, the insert 12 of FIG. 8 has an arcuate inside surface 18 whose deepest point lies approximately at the center of the inside surface 18 and thus of the insert 12 itself. The ring disc 20 of the insert of FIG. 8 likewise has an arcuate configuration. However, as an alternative it can also be provided that only the inside surface 18 is designed to be arcuate, but not the ring disc 20. The curvature of the insert 12, in particular that of its inside surface 18 and, if applicable, its ring disc 20 as well, run parallel to the curvature of the inside bottom surface 15 of the bottom 13 of the cup body 11. The radius of the curvature of the insert 12, especially of its inside surface 18 and/or of the ring disc 20, measures 60 mm to 100 mm, in particular 70 mm to 85 mm.

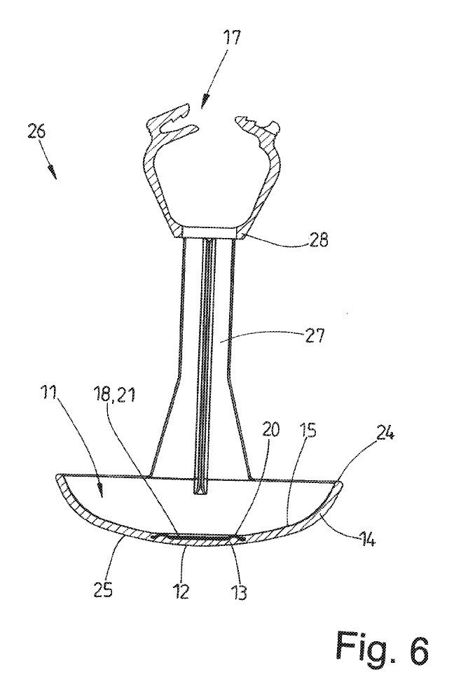

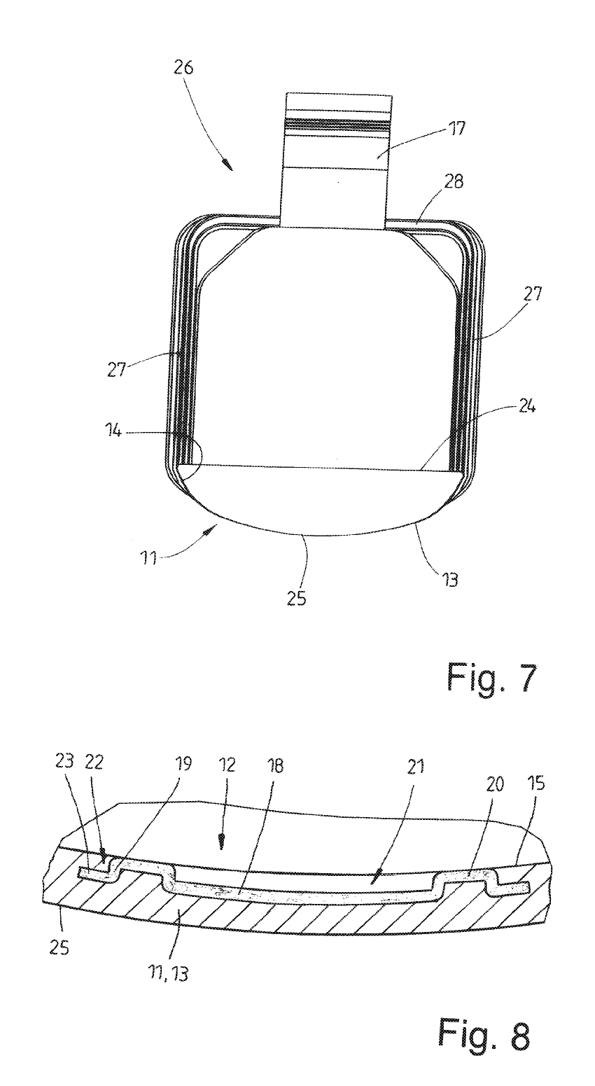

Furthermore, the insert 12 of FIG. 8 corresponds to the insert of FIG. 4, which is why reference is made to the insert 12 described in connection with FIGS. 1 to 7.

The insert 12 is centrally recessed and/or embedded in the bottom 13 of the cup body 11. In order to make this possible, the overall height of the insert 12 between the top side of the ring disc 20 and the bottom side of the inside surface 18 is less than the thickness of the bottom 13 of the cup body 11 in the region of the insert 12. The thickness of the bottom 13 is preferably 1½ to 2 times greater than the overall height of the insert 12 (FIG. 4).

The insert 12 is recessed in the bottom 13 from above to the extent that the top side of the ring disc 20 sits approximately centrally flush with the inside bottom surface 15 of the cup body 11. As a result, the inside bottom surface 15 of the cup body 11 makes a continuous transition to the top side of the ring disc 20 of the insert 12. The top side of the ring disc 20 as well as the depression 21 of the insert 12 are thereby not covered by the plastic material of the bottom 13 of the cup body 11. The top side of the ring disc 20 and the depression 21, in particular its inside surface 18, are thus exposed, with the result that animals wishing to access remaining water from the depression 21 peck their beaks on the inside surface 18 of the depression 21 and possibly the ring disc 20, but not on the outer part of the bottom 13 which surrounds the ring disc 20 and is made of plastic material.

In contrast to the ring disc 20 and depression 21, the outer collar 22, in particular the limb 23 of same that forms an circumferential ring, is completely embedded in the plastic material of the bottom 13 which surrounds the insert 12 on account of its graduated configuration. As a result, a thin layer of the inside bottom surface 15 of the cup body 11, which is made of plastic material, is located above the outer collar 22, in particular above its circumferential limb 23. The insert 12 is thereby embedded in a form-fit manner in this surrounding plastic of the bottom 13 and thus fixed in the bottom 13.

In contrast to the top side of the insert 12, the complete bottom side of the insert 12 is covered or overlaid by the plastic of the bottom 13 of the cup body 11 (FIG. 4). As a result, an outside bottom surface 25 of the cup body 11 is made completely of plastic material and the insert 13 is not visible from the outer bottom surface 25 under the bottom 13.

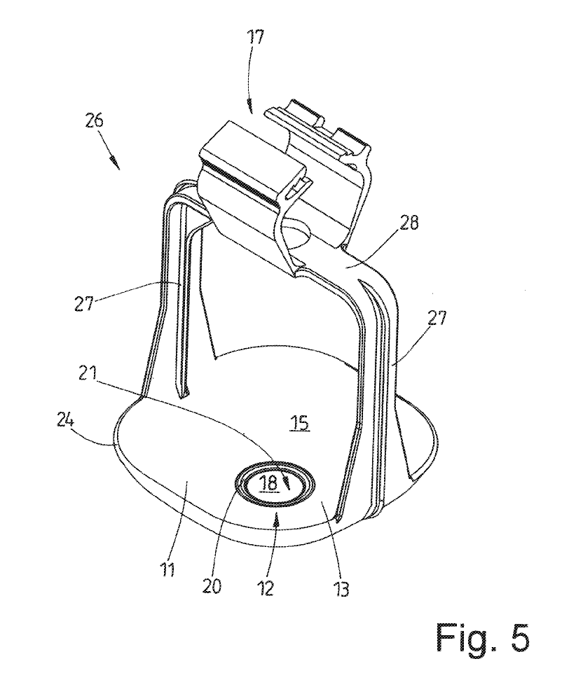

FIGS. 5 to 7 show a drip cup 26 which has two opposing and identical supporting arms 27 which are connected to each other at their upper ends by a web 28, with a clip closure 17 or other attachment means being centered on the web. Furthermore, the drip cup 26 corresponds to the drip cup 10 of FIGS. 1 to 4. For that reason, the same reference numbers will be employed for the same parts involved. In particular the cup body 11 and the insert 12 in the case of the drip cup 26 have the same configuration as the drip cup 10. Above all, the insert 12 in the drip cup 26 also has a graduated or stepped configuration and is recessed and/or embedded in the bottom 13 of the cup body 11. Further, in order to avoid repetition in the following, reference is made to the description of the drip cup 10, in particular its cup body 11 and its associated insert 12.

The shown drip cups 10 and 26 have identical cup bodies 11. These cup bodies 11 have a square base area with highly rounded corners. Accordingly, a free upper rim 24 of the edging 14 of the respective cup body 11 runs along square-shaped course with rounded corners. However, the invention is also suitable for drip cups whose cup bodies have a different base area or geometry. For example, the cup bodies may have round or even oval base areas with a round or oval rim. It is also conceivable to configure the bottoms of the cup bodies to be planar or nearly planar.

### LIST OF DESIGNATIONS

10 drip cup
11 cup body
12 insert
13 bottom
14 edging
15 inside bottom surface
16 supporting arm
17 clip closure
18 inside surface
19 collar
20 ring disc
21 depression
22 collar
23 long limb
24 upper edge
25 outer bottom surface
26 drip cup
27 supporting arm
28 web

What is claimed is:

1. A drip cup for an animal drinker for beaked animals such as chickens, ducks, turkeys and chicks, comprising:
a cup body made of plastic material for accommodating a supply of water and having a bottom and edging surrounding the bottom, the bottom being assigned a preferably central insert made of a resistant material; and
at least one supporting arm for connecting the cup body to a water supply line,
wherein the insert has a graduated configuration.

2. The drip cup as claimed in claim 1, wherein the insert is graduated in the manner of a hat.

3. The drip cup as claimed in claim 1, further comprising a depression present in the insert and formed by the graduated configuration of the insert.

4. The drip cup as claimed in claim 3, wherein the depression has an inside surface and a raised collar which surrounds the inside surface.

5. The drip cup as claimed in claim 3, wherein the depression in the insert is surrounded by a ring disc.

6. The drip cup as claimed in claim 5, wherein the ring disc is joined with an upper edge of the collar of the depression surrounding the inside surface.

7. The drip cup as claimed in claim 4, wherein the inside surface has a planar configuration.

8. The drip cup as claimed in claim 4, wherein a lowest point of the inside surface is located at the center of the inside surface.

9. The drip cup as claimed in claim 5, wherein the ring disc has a planar configuration.

10. The drip cup as claimed in claim 6, wherein the inside surface and the ring disc lie in different, parallel planes, wherein the inside surface is arranged below the ring disc.

11. The drip cup as claimed in claim 10, wherein the plane of the inside surface lies below the plane of the ring disc.

12. The drip cup as claimed in claim 6, wherein the wall of the collar surrounding the inside surface runs at a right angle to the ring disc.

13. The drip cup as claimed in claim 5, wherein an outer edge of the ring disc is surrounded by a collar.

14. The drip cup as claimed in claim 13, wherein in that the collar is double-angled and has an L-shaped profile.

15. The drip cup as claimed in claim 14, wherein a limb of the L-shaped profiled collar has a free end and lies at least in part in the plane or near the plane of the inside surface of the insert.

16. The drip cup as claimed in claim 5, wherein the inside surface of the depression is circular in shape and that the ring disc, which surrounds the depression and is higher than the latter, is configured to be circular in shape.

17. The drip cup as claimed in claim 1, wherein the entire insert is formed as single piece.

18. The drip cup as claimed in claim 1, wherein the entire insert is made of steel.

19. The drip cup as claimed in claim 1, wherein the insert is recessed in the bottom of the cup body.

20. The drip cup as claimed in claim 19, wherein the insert is disc of the insert is approximately flush with the inside surface of the bottom.

21. The drip cup as claimed in claim 19, wherein the outer collar surrounding the outside of the ring disc and situated lower with respect to the ring disc is embedded in the bottom of the cup body in that it is covered by the plastic material of the inside surface of the bottom of the cup body.

22. The drip cup as claimed in claim 1, wherein a bottom side of the entire insert is covered by the plastic material of an external bottom surface of the bottom of the cup body.

23. An animal drinker for beaked animals such as chickens, ducks, turkeys, chicks and the like, comprising:
at least one drinker valve positioned on a water supply line; and
a drip cup assigned to the at least one drinker valve, wherein the drip cup comprises:
a cup body made of plastic material for accommodating a supply of water and having a bottom and edging surrounding the bottom, the bottom being assigned a preferably central insert made of a resistant material, wherein the insert has a graduated configuration; and
at least one supporting arm for connecting the cup body to a water supply line.
